(19) United States
(12) Patent Application Publication
(10) Pub. No.: US 2008/0307359 A1
(43) Pub. Date: Dec. 11, 2008

(54) Grouping Graphical Representations of Objects in a User Interface

(75) Inventors: John O. Louch, San Luis Obispo, CA (US); Christopher Hynes, Santa Cruz, CA (US); Timothy Wayne Bumgarner, Sharpsburg, MD (US); Eric Steven Peyton, Lisle, IL (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 11/760,526

(22) Filed: Jun. 8, 2007

(51) Int. Cl. G06F 3/048

(52) U.S. Cl. 715/835

(57) ABSTRACT

Graphical representations of distinct system objects are associated into a group. The group is displayed in a user interface as a graphical element having one or more views. The group can be collapsed into a stack and gestures can be applied to group. Operations are performed on the group in response to user inputs. A selection of the group causes a control to appear in a graphical use interface. The control identities the operations that can be applied to the group.

### BACKGROUND

A graphical user interface allows a large number of graphical objects or items to be displayed on a display screen at the same time. Personal computer operating systems, such as Apple Mac OS®, provide user interfaces in which a number of graphical representations of system objects, such as windows, icons representative of files, peripherals, applications, and other representations of system objects can be displayed according to the needs of the user. Taskbars, menus, virtual buttons, a mouse, a keyboard, and other user interface elements provide mechanisms for accessing and/or activating the system objects corresponding to the displayed representations.

The graphical objects provide access to the corresponding system objects and related functions, however, they should be presented in a manner that facilitates an intuitive user experience. The use of metaphors that represent concrete, familiar ideas facilitates such an intuitive user experience. For example, the metaphor of file folders cart be used for storing documents; the metaphor of a file cabinet can be used for storing information on a hard disk; and the metaphor of the desktop can be used for an operating system interface.

As the capabilities of processing devices progress, however, so to do the demands on the graphical user interface to convey information to the users in an intuitive manner.

### SUMMARY

Disclosed herein is a multidimensional desktop graphical user interface. In one implementation, a graphical user interface includes a group element containing graphical representations of at least two distinct types of system objects. The group element is associated with an operation that is performed on system objects, such as a move operation, a copy operation, an archive operation, or an open operation. The graphical user interface includes a control element associated with the group element. The control element activates the operation upon receipt of a user input.

In another implementation, a group is created from a received selection of graphical representations of distinct system objects. The graphical representations are identified as part of the group by a view in a graphical user interface. Items within the group can be having different views to distinguish between the items within the group.

In another implementation, a selection of the group is received based on a user input. An operation selection element is displayed providing a choice of operations that can be performed on the group. An operation is selected from the operation selection element and applied to the group.

In another implementation, a sub-group is defined within the group. A different view can be applied to the sub-group to identify it as a sub-group within a group. A selection of operations can be applied to the sub-group in response to a user input. The operations applied to the sub-group can be different that operations that are applied to its group.

### BRIEF DESCRIPTION OF THE DRAWINGS

FIG. 1 is a block diagram of an example system that can be utilized to implement the systems and methods described herein.

FIG. 2 is a block diagram of an example user interface architecture.

FIG. 3 is an image of art example icon receptacle.

FIG. 4 is an image of an example stack item.

FIG. 5 is a block diagram of an example user interface engine architecture.

FIG. 6 is block diagram of example system layer structure that can be utilized to implement the systems and methods described herein.

FIG. 7 is a block diagram of an example multidimensional desktop environment.

FIG. 8 is another block diagram of the example multidimensional desktop environment.

FIG. 9 is another block diagram of the example multidimensional desktop environment.

FIG. 10 is another block diagram of the example multidimensional desktop environment.

FIG. 11 is a block diagram of another example multidimensional desktop environment.

FIG. 12 is a block diagram of another example multidimensional desktop environment.

FIG. 13 is a block diagram of another example multidimensional desktop environment

FIG. 14 is a flow diagram of an example process for creating a group.

FIG. 15 is a flow diagram of an example process for performing an operation on a group.

FIG. 16 is a flow diagram of an example process for creating an empty group and associating graphical representations into the empty group,

FIG. 17 is a flow diagram of art example process for applying a view to a group.

FIG. 18 is a flow diagram of an example, process for creating a group in an application environment.

### DETAILED DESCRIPTION

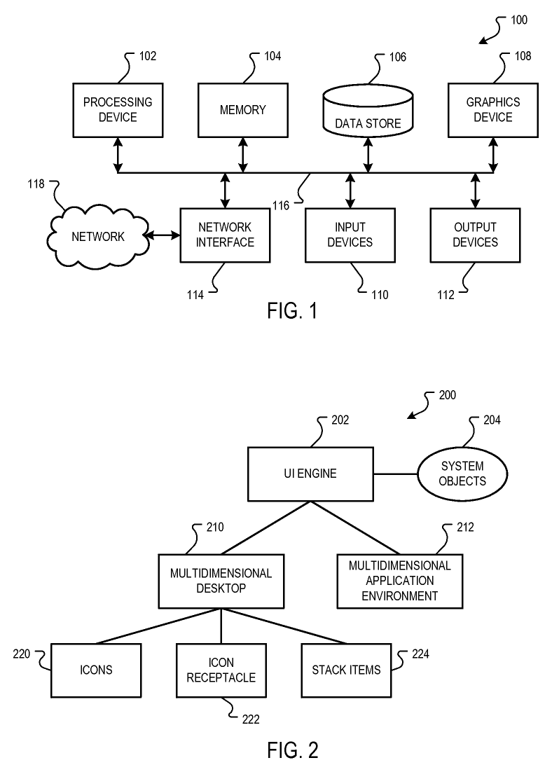

FIG. 1 is a block diagram of an example system 100 that can be utilized to implement the systems and methods described herein. The system 100 can, for example, be implemented in a computer device, such any one of the personal computer devices available from Apple, Inc., or other personal computer devices. Other example implementations can also video processing devices, multimedia processing devices, portable computing devices, portable electronic devices, etc.

The example system 100 includes a processing device 102, a first data store 104, a second data store 106, a graphics device 108, input devices 110, output devices 112, and a network device 114. A bus system 116, such as a data bus and a motherboard, can be used to establish and control data communication between the components 102, 104, 106, 108, 110, 112 and 114. Other example system architectures, however, can also be used.

The processing device 102 can, for example, include one or more microprocessors. The first data store 104 can, for example, include a random access memory storage devices, such as a dynamic random access memory, or other types of computer-readable medium memory devices. The second data store 106 can, for example, include one or more hard drives, a flash memory, and/or a read only memory, or other types of computer-readable medium memory devices.

The graphics device 108 can, for example, include a video card, a graphics accelerator card, or display adapter and is configured is to generate and output images to a display device. In one implementation, the graphics device 108 can be realized in a dedicated hardware card connected to the bus system 116. In another implementation, the graphics device 108 can be realized in a graphics controller integrated into a chipset of the bus system 116. Other implementations can also be used.

Example input devices 110 can include a keyboard, a mouse, a stylus, a video camera, etc., and example output devices 112 can include a display device, an audio device, etc.

The network interface 114 can, for example, include a wired or wireless network device operable to communicate data to and from a network 118. The network 118 can include one or more local are networks (LANs) or a wide area network (WAN), such as the Internet.

In an implementation, the system 100 includes instructions defining an operating system stored in the first data store 104 and/or the second data store 106. Example operating systems can include the MAC OS® X operating system, the WINDOWS® operating system, Unix-bases operating systems, or other operating systems. Upon execution of the operating system instructions, access to various system objects is enabled. Example system objects include data files, applications, functions, windows, etc. To facilitate an intuitive user experience, the system 100 includes a graphical user interface that provides the user access to the various system objects and conveys information about the system 100 to the user in an intuitive manner.

FIG. 2 is a block diagram of an example user interface architecture 200. The user interface architecture 200 includes a user interface (UI) engine 202 that provides the user access to the various system objects 204 and conveys information about the system 100 to the user.

Upon execution, the UI engine 202 can cause the graphics device 108 to generate a graphical user interface on an output device 112, such as a display device. In one implementation, the graphical user interface can include a multidimensional desktop 210 and a multidimensional application environment 212. In an implementation, the multidimensional desktop 210 and the multidimensional application environment 212 include x-, y- and x-axis aspects, e.g., a height, width and depth aspect. The x-, y- and z-axis aspects may define a three-dimensional environment, e.g., a “3D” or “2.5D” environment that includes a z-axis, e.g., depth, aspect.

In an implementation, the multidimensional desktop 210 can include icons 220, an icon receptacle 222, and stack items 224. The icons 220, the icon receptacle 222, and the stack items 224 can be presented in the three dimensional environment as graphical objects having a depth aspect.

In an implementation, the multidimensional application environment 212 can include an application environment distributed along a depth aspect. For example, a content frame, e.g., an application window, can be presented on a first surface, and control elements, e.g., toolbar commands, can be presented on a second surface.

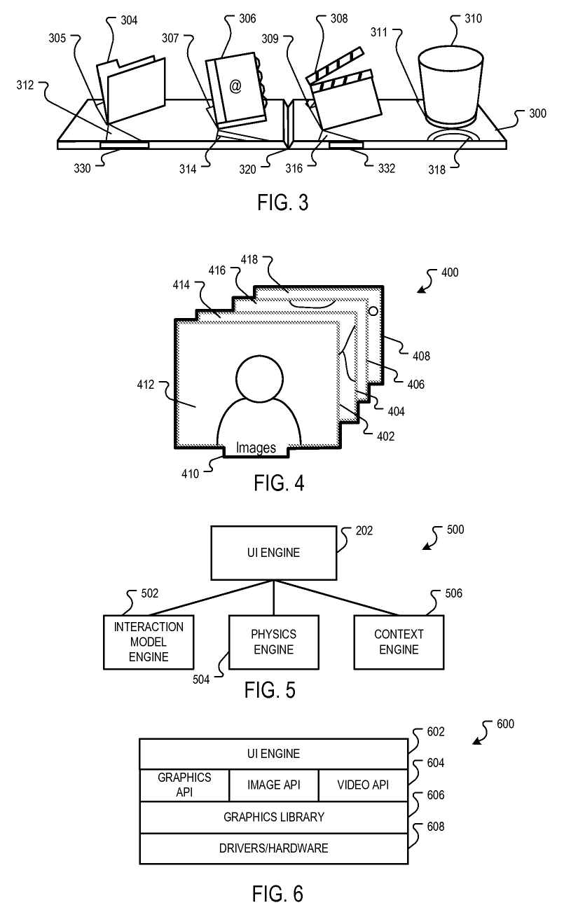

FIG. 3 is an image of an example icon receptacle 300. In one implementation, the icon receptacle 300 can, for example, include a receptacle 302 having x-, y- and z-axis aspects, e.g., a height, width and depth. In another implementation, the receptacle 302 can have only a y- and z-axis aspect, e.g., a width and depth.

One or more icons 304, 306, 308 and 310 can be disposed within the icon receptacle 300. In one implementation, a lighting and shading effect is applied to emphasize the depth aspect of the icon receptacle 300, as illustrated by the corresponding reflections beneath each of the icons 304, 306, 308 and 310. Additional features of the icon receptacle 300 and icons disposed therein are described in more detail below.

FIG. 4 is an image of an example stack item 400. In one implementation, the stack item 400 includes a plurality of stack elements, e.g., stack elements 402, 404, 406 and 408, such as icons corresponding to system objects. The stack item 400 is associated with the stack elements 402, 404, 406 and 408 so that selection of the stack item can provide access to any of the stack elements 402, 404, 406 and 408.

In one implementation, a stack item identifier 410 can be displayed on the top stack element, e.g. stack element 402. In one implementation, the stack item identifier 410 can, for example, comprise a title describing a stack type, e.g., “images” or “documents.” In another implementation, the stack item identifier 410 can, for example, comprise a visual indicator indicating an aspect of the stack, e.g., the dollar sign $ can be displayed for a stack item related to system objects used in a financial analysis tool. Other stack identifiers can also be used.

In one implementation, the stack elements 402, 404, 406 and 408 are aggregated in an overlapping arrangement as shown in FIG. 4. Other stack arrangements can also be used. In one implementation, each stack element 402, 404, 406 and 408 displays a corresponding unique indicium 412, 414, 416 and 418, e.g., a thumbnail preview of an image associated with the stack element or the first page of a document associated with the stack element. Other unique indicium or unique indicia can also be used. For example, stack items corresponding to images can he of the same aspect of the image, e.g., a 4×5 aspect and 9×12 aspect, etc. Likewise, stack items corresponding to documents can be of the same aspect of a paper selection, e.g., a 8.5×11 aspect, an A4 aspect, etc. Other unique indicium can also be used, e.g., a document size and/or a document date can be displayed in each stack element, etc. Additional features of the stack item 400 and corresponding stack elements are described in more detail below.

The stack item 400 can include icons related to different types of system objects. For example, a stack item can include stack elements related to peripheral devices, e.g., hard drives, universal serial bus devices, etc; or can include stack elements related to application windows; or can include stack elements related to system functions, e.g., shutdown, sleep, backup, etc., or other system objects.

FIG. 5 is a block diagram of an example user interface engine architecture 500. The UI engine 202 can, for example, include an interaction model engine 502, a physics engine 504, and a context engine 506. Other engines can also be included.

In one implementation, the interaction model engine 502 can identify association characteristics of associated graphical elements, e.g., icons. The associated graphical elements can be collectively displayed, e.g., in an object stack, or can be distributed in a desktop/folder hierarchy in which only one icon is displayed. Based on the identified characteristic, the interaction model engine 502 can automatically select an interaction model that defines how the user may interact with the associated graphical elements. For example, if an identified association characteristic is the quantity of associated icons, an interaction model for browsing the documents related to the icons can be selected based on the quantity. For example, if the quantity of associated icons is less than a first threshold, e.g., four, a mouse-over of any one of the four associated icons can present the associated icons in juxtaposition. Likewise, if the quantity of associated icons is greater than the first threshold and less than a second threshold, e.g., 16, a mouse-over of any one of the associated icons can present the associated icons in an overlapping display in which icons cycle from back to front. Additionally, if the quantity of associated icons is greater than the second threshold, then a mouse-over of any one of the associated icons can present a scrollable list of associated documents. Other interaction models and selection schemes can also be implemented.

In one implementation, the physics engine 504 can apply a physics aspect, such as Newtonian physics models based on mass, velocity, etc., to the visual representations of system objects, such as icons. In an implementation, the icons or groups can be modeled as rigid bodies or non-rigid bodies. For example, placing an icon or group on a surface next to adjacent icons or groups can cause the adjacent icons or groups to shift positions in response to a simulated disturbance from the icon or group placement. In one implementation, icon or group magnetism can be selectively enabled or disabled by the user. In one implementation, icons or groups return to their initial positions upon a disabling of the magnetism aspect. In another implementation, a magnet icon or group can have a magnetism aspect selected by the user, e.g., a magnetism with respect to a word processing application, or a magnetism with respect to two or more applications, or a magnetism with respect to the last time a document was accessed, e.g., within the last two days, etc.

Other physics models can also be applied. For example, an application icon or group can include a magnetism aspect, and placing the magnetic application icon or group on the desktop can cause icons or groups related to the application icon or group, e.g., icons or groups representing application document files, to be attracted to the magnetic icon or group and move towards the magnetic icon or group. Likewise, icons or groups for unrelated system objects, e.g., other application icons or groups and other document icons or groups, can be modeled as having an opposite magnetic polarity from the selected magnetic icon or group, and thus will be repulsed and shift away from the selected magnetic icon or group.

The context engine 506 can, for example, provide contextual control of a stack item based on a context. For example, stack items, such as the stack item 400, can be defined according to a protection context. Accordingly, system objects corresponding to stack elements within the stack item cannot be deleted until dissociated from the stack item. Other contextual control can also be provided, such as contextual control based on a temporal context, or an execution context, or other context types.

FIG. 6 is block diagram of example system layers 600 that can be utilized to implement the systems and methods described herein. Other system layer implementations, however, can also be used.

In an implementation, a UI engine, such as the UI engine 202, operates an application level 602 and implements graphical functions and features available through an application program interface (API) layer 604. Example graphical functions and features include graphical processing, supported by a graphics API, image processing, support by an imaging API, and video processing, supported by a video API.

The API layer 604, in turn, interfaces with a graphics library layer 606. The graphics library layer 604 can, for example, be implemented as a software interface to graphics hardware, such as an implementation of the OpenGL specification. A driver/hardware layer 608 includes drivers and associated graphics hardware, such as a graphics card and associated drivers.

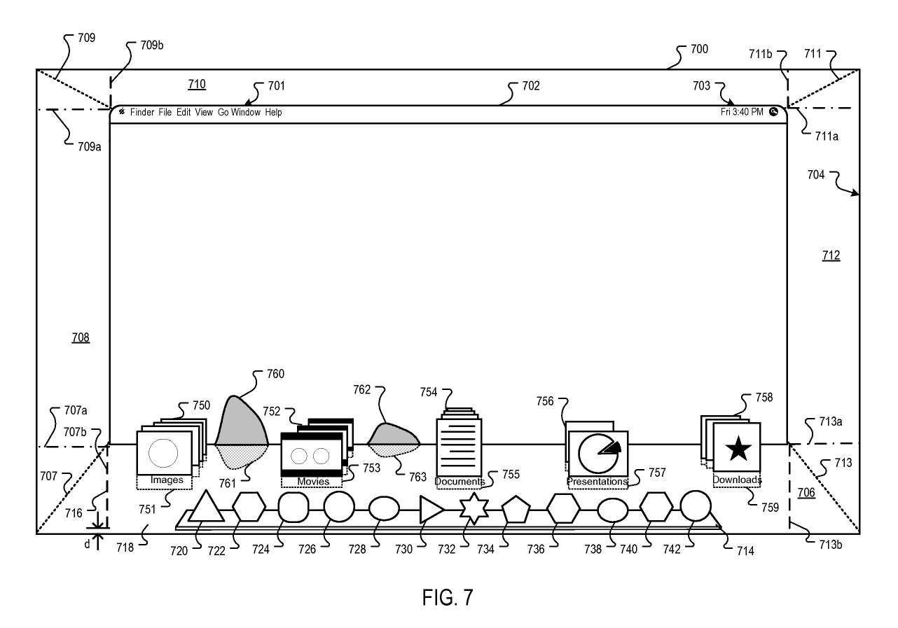

FIG. 7 is a block diagram of an example multidimensional desktop environment 700. In the example implementation, the multidimensional desktop environment 700 includes a back surface 702 is axially disposed, e.g., along the z-axis, from a viewing surface 704. In one implementation, the viewing surface can be defined by the entire image on a display device, e.g., a “front pane.” One or more side surfaces, such as side surfaces 706, 708, 710 and 712, are extended from the back surface to the viewing surface. An icon receptacle 714 is generated on one or more of the side surfaces, such as side surface 706.

In one implementation, a reflection region 716 can be generated on the side surface 706, e.g., the “floor.” In an implementation, the icon receptacle 714 is positioned at a forward terminus 718 of the reflection region 716. In one implementation, the forward terminus 718 can be offset an axial distance d from the viewing surface 704. In another implementation, the forward terminus 718 can terminate at the plane defined by the viewing surface 704.

In an implementation, the side surfaces 706, 708, 710 and 712 can intersect at intersections 707, 709, 711 and 713, respectively. Although four side surfaces are shown in FIG. 7, fewer or more side surfaces can be defined; for example, in an implementation, only side surfaces 706, 708 and 712 are defined, and there is an absence of a “top” side surface 710.

In an implementation, the side surfaces 706, 708, 710 and 712 are colored to emphasize the back surface 702 and reflection region 716. For example, the side surfaces 706, 708, 710 and 712 can be colored black, or respective patterns or colors can be rendered on each side surface. Other color schemes and image schemes can also be applied.

The icon receptacle 714 can include a plurality of icons 720, 722, 724, 726, 728, 730, 732, 734, 736, 738, 740 and 742. The icons 720, 722, 724, 726, 728, 730, 732, 734, 736, 738, 740 and 742 can, for example, include graphical representations corresponding to one or more system objects, such as applications, documents, and functions. The icon receptacle 714 and icons 720, 722, 724, 726, 728, 730, 732, 734, 736, 738, 740 and 742 can be displayed as described with respect to the more detailed icon receptacle 300 of FIG. 3.

In an implementation, stack items 750, 752, 754, 756 and 758 are interposed between the icon receptacle 714 and the back surface 702. The stack items 750, 752, 754, 756 and 758 can be displayed and be responsive to interactions as described with respect to FIG. 4 above. Selection of a particular stack element in a stack item can, for example, launch an associated application if the stack element represents an application document; or perform a system function if the stack element represents a system function, or can instantiate some other system process.

In an implementation, a stack item can be placed on the icon receptacle 714. In another implementation, behavior of a stack item when on the icon receptacle 714 is similar to the behavior of the stack item when placed on the reflection region 716.

In an implementation, representations of system objects, e.g., icons, stack items, etc., can be disposed on the side surfaces 708, 710 and 712. For example, a window displayed on the back surface 702 can be selected and dragged to one of the side surfaces 708, 710, or 712. Likewise, a stack item, such as stack item 750, can be dragged and disposed on one of the side surfaces 708, 710, or 712.

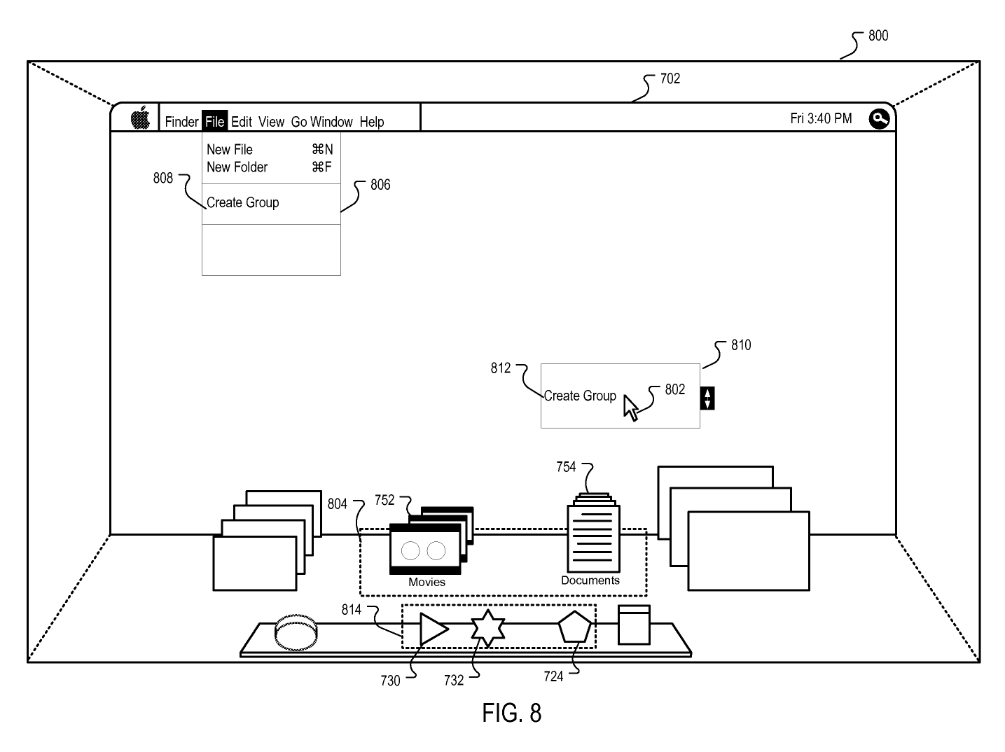

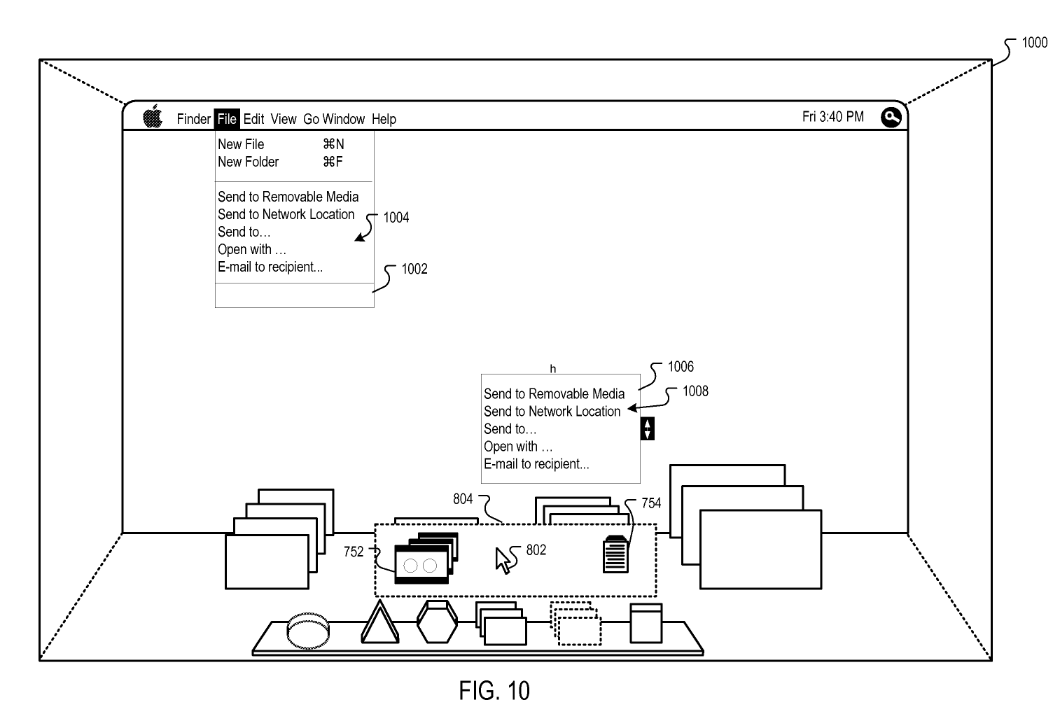

FIG. 8 is another block diagram of the example multidimensional desktop environment 800 illustrating graphical representations of system objects arranged into a group. Groups contain graphical representations (e.g., icons, stacks, thumbnails, or other graphical elements) of distinct system objects that represent different applications, documents, or functions, and define a relationship between its members through a mode of operation that otherwise would not exist. Exemplary operations are described below with reference to FIGS. 10-13.

In the example implementation, a group 804 is defined that includes the stack items 752 and 754. In the example implementation, the stack item 752 represents a first type of system object (e.g., movie files) and the stack item 754 represents a second type of system object (e.g., documents).

In an implementation, the group 804 is created by, for example, dragging a mouse pointer 802 over the stack items 752 and 754 to select the stack items. Other means for selection can be used. Thereafter a grouping operation can be initiated. For example, a menu 806 can be provided within the desktop environment 800 basing a create group option 808. Selecting the create group option 808 creates the group 804 as a graphical element on the desktop environment 800 containing the selected stack items 752 and 754.

In another implementation, the group 804 is created using a context-sensitive pop-up menu 810. The context-sensitive pop-up menu 810 is displayed in response to, for example, a mouse-over of the selected stack items 752 and 754, a keyboard key combination, a keyboard/mouse operation, or by a control provided in the desktop environment 800. A create group option 812 can be provided in the context-sensitive pop-up menu 810 to create the group 804 containing the selected stack items 752 and 754. Other control elements can be used in addition to the context-sensitive pop-up menu.

In the above implementations, additional, graphical representations of objects can be added to the group or selected as initial members of the group. For example, stack items 750, 756 or 758 can be added to the group 804.

In other implementations, the group 804 can he created by selecting individual graphical representations through a control-click operation, a keyboard operation, a mouse-over operation or a control provided within the desktop environment 800.

In an implementation, a group 814 can be created that includes a different set of graphical representations of system objects. The group 814 includes icons 724, 730 and 732, each representative of a distinct type of application or function. Although FIG. 8 illustrates two groups, additional or fewer groups can be created within the desktop environment 800.

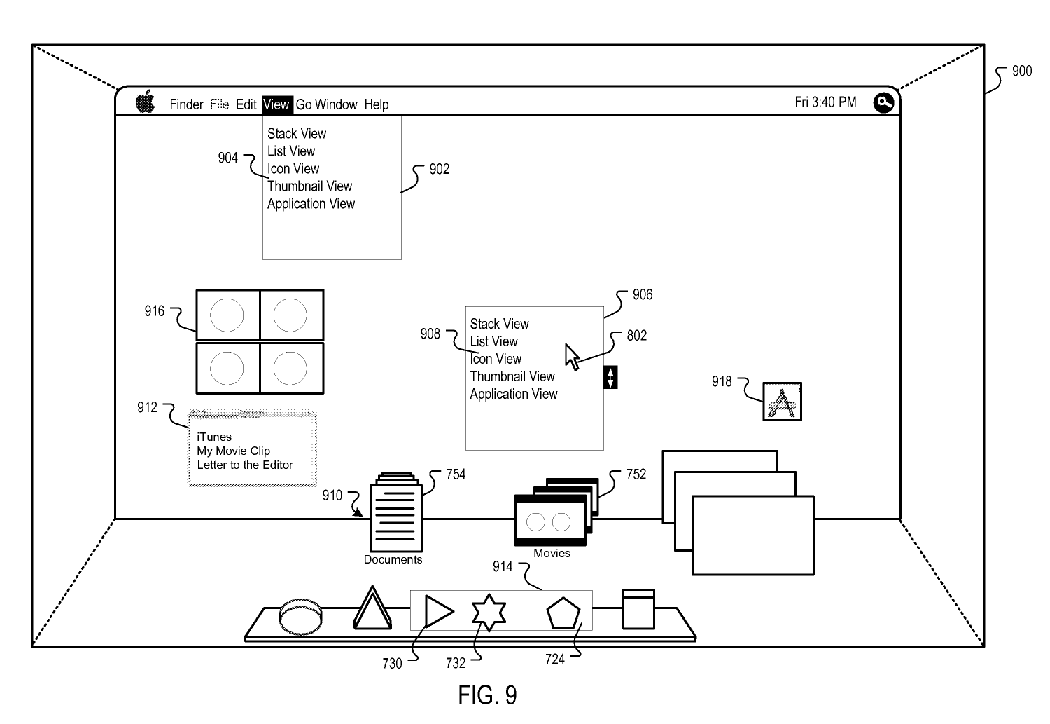

FIG. 9 is another block diagram of the example multidimensional desktop environment 900. FIG. 9 illustrates views that can be applied to groups. In an implementation, a view is selected by dragging a mouse pointer 802 over the group, or selecting the group using the mouse or by a keyboard key combination. A menu 902 can be provided within the desktop environment 900 listing several options 904 for the group view. For example, views such as a stack view, a list view, an icon view, a thumbnail view or an application view are provided. Selecting a particular view organizes the group into that view.

In another implementation, the view is selected using a context-sensitive pop-up menu 900. The context-sensitive pop-up menu 906 is displayed in response to, for example, a mouse-over of the group, a keyboard key combination, a keyboard/mouse operation, or by a control provided in the desktop environment 900. View options 908 are listed in the context-sensitive pop-up menu 906 to set or change the view of a particular group, as in the menu 902. Other control elements can be used in addition to the context-sensitive pop-up menu.

In an implementation, a stack view applied to a group organizes the stack items 752 and 754 into a stack 912. In an implementation the stack stems 752 and 754 can each be graphical representations of distinct system objects. For example, the stack item 752 is a thumbnail view of the contents of a movie file, whereas the stack item 754 is an icon representative of a document type. In an implementation, the items within the stack can be any type of graphical representation. The backgrounds of the items can be different to create a picture in picture effect.

In an implementation, a list view 912 lists contents of the group. For example the list view 912 lists a group that includes an iTunes application, a movie clip called “My Movie Clip,” and a document entitled “Letter to the Editor.”

In another implementation, an application view 914 illustrates members of the group as application icons 724, 730 and 732. The icons 724, 730 and 732 can provide a readily recognizable indication of applications that run in an application environment. In another implementation, a thumbnail view 916 shows items within the group as thumbnails of the contents within each item. In another implementation, an icon view 918 represents the group as an icon.

In another implementation, gestures can he applied to the views to manipulate a group within the desktop environment 800 to manipulate the groups as physical objects. Gestures are interpreted by physics engine 504 to determine characteristics of movement and interaction.

FIG. 10 is another block diagram of the example multidimensional desktop environment 1000. FIG. 10 illustrates example operations that can be performed on a group. As noted above, the operation applied to the group forms the relationship between the distinct items within the group. In the example implementation, the group 804 includes the stack items 752 and 754. In an implementation, the group 804 is selected by the mouse pointer 802. A menu 1002 is provided within the desktop environment 1000 listing operations 1004 that can be performed on the group 804. The operations 1004 can he determined based on the system objects contained within the group or specified by a user. In the example desktop environment 1000, the operations 1004 include “Send to Removable Media,” “Send to Network Location,” Send to . . . ” (allowing the user to specify a destination), “Open with . . . ” (allowing a user to select an application, and “E-mail to recipient . . . ” (allowing a user to select an e-mail recipient from an address book). Other operations 1004 can be provided or specified.

In another implementation, a context-sensitive pop-up menu 1006 is displayed in response to a mouse-over of the group 804, a keyboard key combination, a keyboard/mouse operation, or by a control provided in the desktop environment 1000. Operations 1008, such as thee operations 1006, are provided to be performed on the group 804. Other control elements can be used in addition to the context-sensitive pop-up menu.

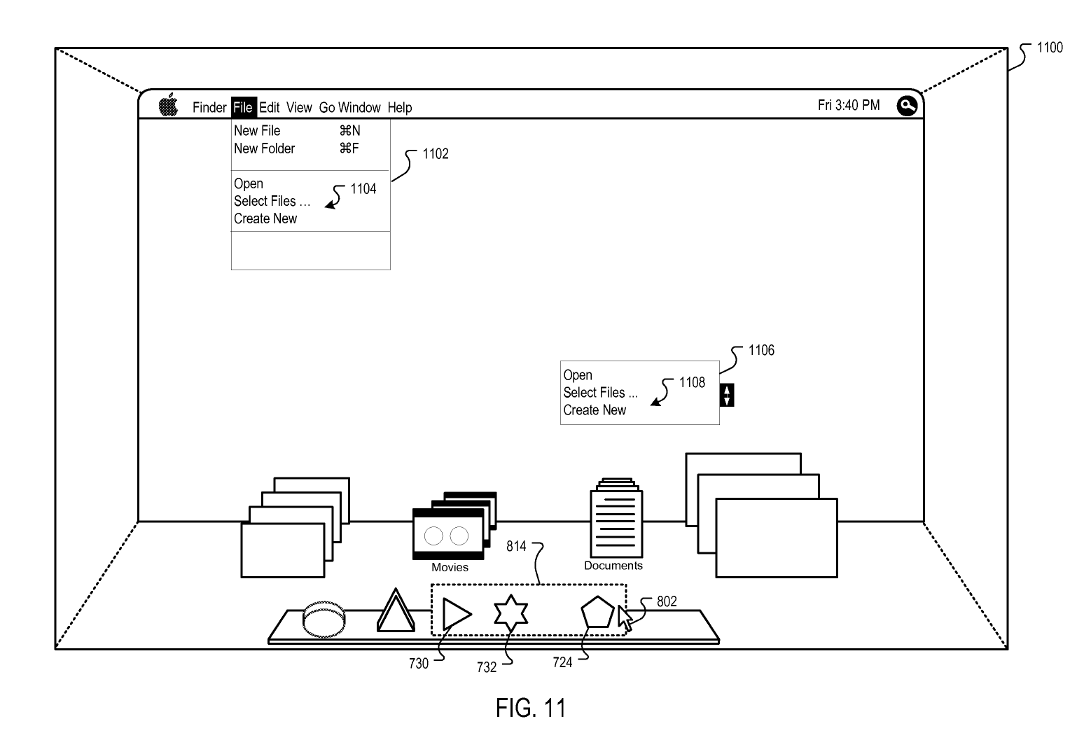

FIG. 11 is another block diagram of the example multidimensional desktop environment 1100 illustrating example operations that can be performed on a group. In the example implementation, the group 814 includes icons 724, 730 and 732, each representative of a distinct type of application or function. As described with reference to FIG. 10, the group 814 can be selected by pointing the mouse pointer 802 on the group 814 to select the group. A menu 1102 can be provided within the desktop environment 1100 listing operations 1104 that can be performed on the group 814. The example operations 1104 can be determined based on the system objects contained within the group 814 or specified by the user. The example operations 1104 include “Open,” “Select Files . . . ” and “Create New.” Other operations 1104 can be provided or specified to operate on the group 814.

In another implementation, a context-sensitive pop-up menu 1106 is displayed in response to a mouse-over of the group 814, a keyboard key combination, a keyboard/mouse operation, or by a control provided in the desktop environment 1100. Operations 1108 are provided within the context-sensitive pop-up menus 1106 to be performed on the group 814.

As illustrated in the example implementations of the multidimensional desktop environment in FIGS. 10 and 11, different combinations of operations can he performed on groups.

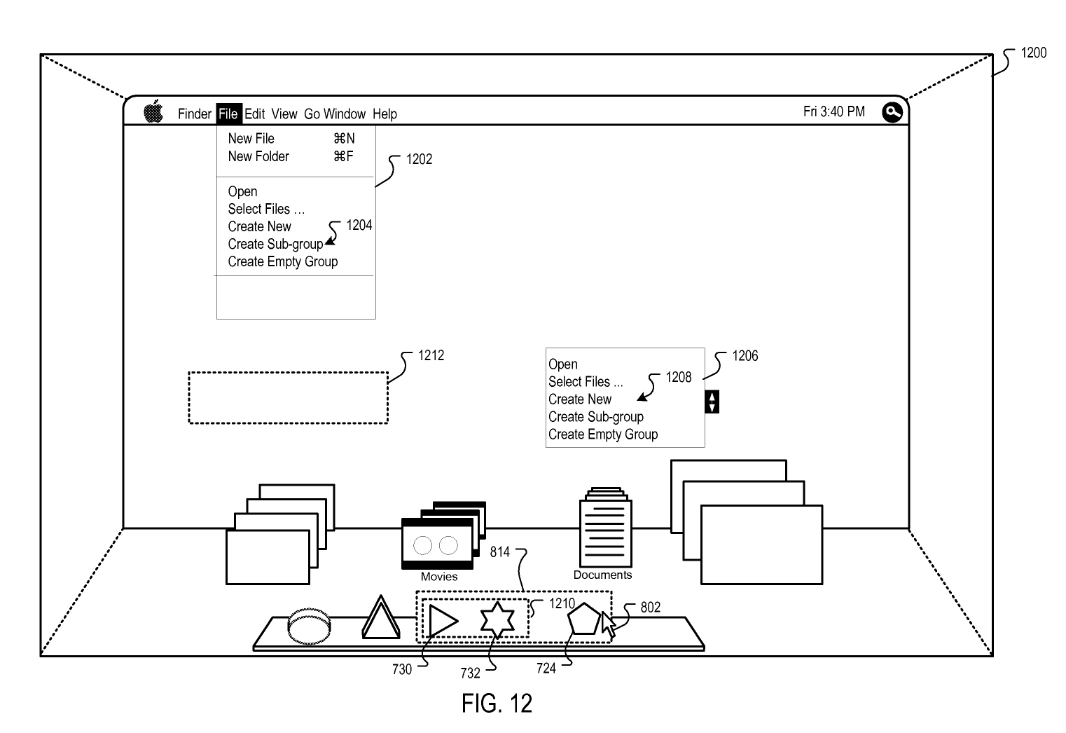

FIG. 12 is another block diagram of the example multidimensional desktop environment 1200. FIG. 12 illustrates graphical representations of system objects arranged into a sub-group 1210 and an empty group 1212. In the example implementation, the sub-group 1210 can be created within the group 814, and contains a subset of the graphical representations in the group 814.

In an implementation, the sub-group 1210 is created by dragging a mouse pointer 802 over the icons 730 and 732 to select the icons. A menu 1202 is provided within the desktop environment 1200 having an option 1204 to create sub-group. Selecting the create sub-group option creates the sub-group 1210 within the group 814.

In another implementation, the sub-group 1210 is created using a context-sensitive pop-up menu 1206 displayed in response to a mouse-over of the icons 730 and 732, a keyboard key combination, a keyboard/mouse operation, or by a control provided in the desktop environment 1200. Options 1208 within the context-sensitive pop-up menu 1206 include a create sub-group option, which when selected creates the sub-group 1210. Other control elements can be used in addition to the context-sensitive pop-up menu.

In the above implementations, additional graphical representations of objects can be added to the sub-group, or selected as members of the sub-group when created. In some implementations, operations, such as those described above with reference to FIGS. 10 and 11, can be performed on the items within the sub-group 1210, where other operations are performed on the group 814.

In some implementations, a group 1212 containing no initial items can he created by selecting the “Create Empty Group” option in either of menus 1202 or 1206. The group 1212 can be populated later by selecting graphical representations and associating them with the group 1212. Operations can he performed on the group 1212 as described above.

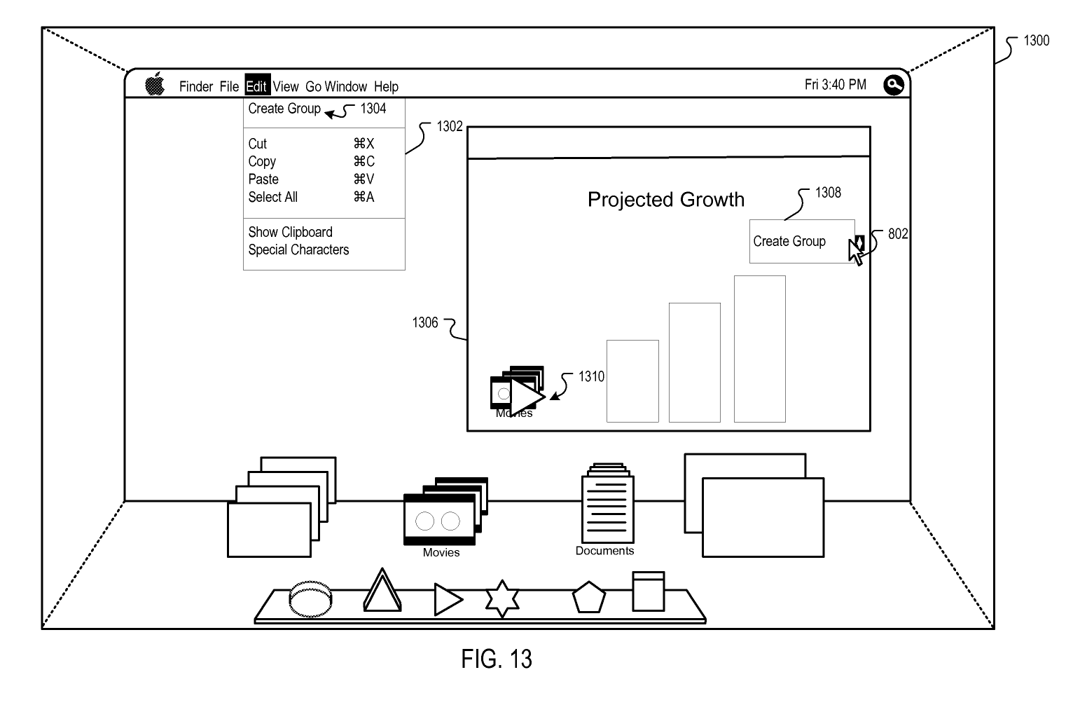

FIG. 13 is another block diagram of the example multidimensional desktop environment 1300. FIG. 13 illustrates a document 1306 being edited within an application environment 1306. A menu 1302 having a Create Group item 1304 or an editing control 1308 is provided to embed a group 1310 within a document being edited in the application environment 1306. In an implementation, launching the document performs operations on the embedded group 1310. In some implementations, operations can be performed on the group 1310 in response to a user input after the application is launched. For example, a group 1310 can be defined that launches application software to edit items within the group 1310, copies files within the group 1310 to a network location, e-mails items within the group 1310, etc. Other-operations can be defined and applied to items within the group 1310.

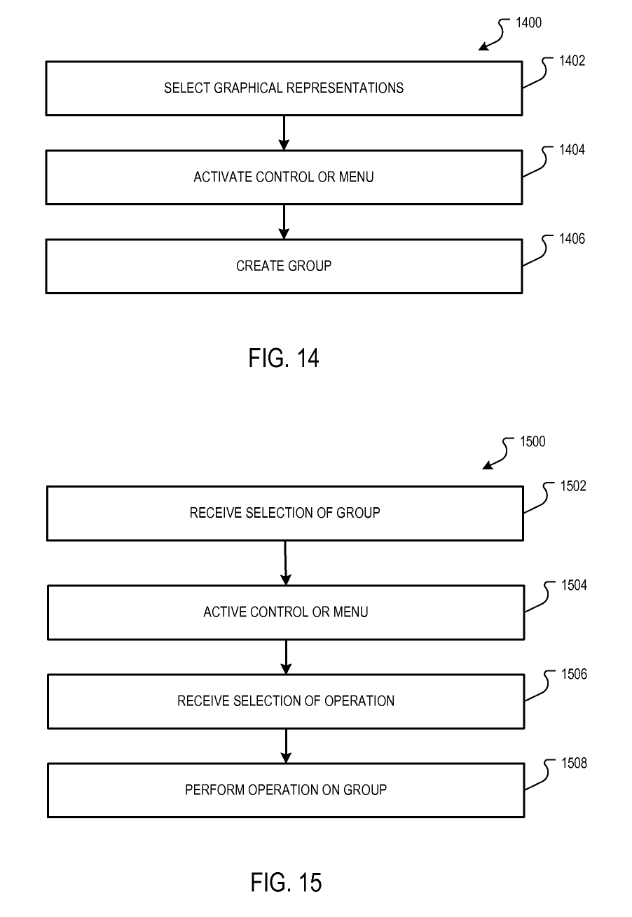

FIG. 14 is a flow diagram of an example process for creating a group. At stage 1402, a selection of graphical representations of system objects is received. For example, a user may select the graphical representations using a mouse pointer, dragging the mouse pointer over the graphical representations, or by a keyboard input.

At stage 1404, a menu or control is activated. For example, a menu within the desktop environment is selected, or a context-sensitive pop-up menu is activated in response to a mouse-over of the graphical representations, a keyboard key combination, a keyboard/mouse operation, or by a control provided in the desktop environment. Other control elements can be used in addition to the context-sensitive pop-up menu.

At stage 1406, the group is created. For example, in response to a user selection of a menu item in stage 1404 an operation to be performed on the group is defined and the group is displayed in the desktop environment within a default or user-selected view.

FIG. 15 is a flow diagram of an example process For performing an operation on a group. At stage 1502, a selection of the group is received. For example, a user may select the group using a mouse pointer, or drag the mouse pointer over the graphical representations.

At stage 1504, a menu or control is activated. For example, a menu within the desktop environment is selected, or a context-sensitive pop-up menu is activated in response to a mouse-over of the group, a keyboard key combination, a keyboard/mouse operation, or by a control provided in the desktop environment.

At stage 1506, the operation to be performed on the group is selected. For example, the operation to be performed on the group is selected in response to a user selection from a list of operations provided on the menu.

At stage 1508, the operation is performed on the group. For example, instructions are executed by the operating system to perform the operation on the group.

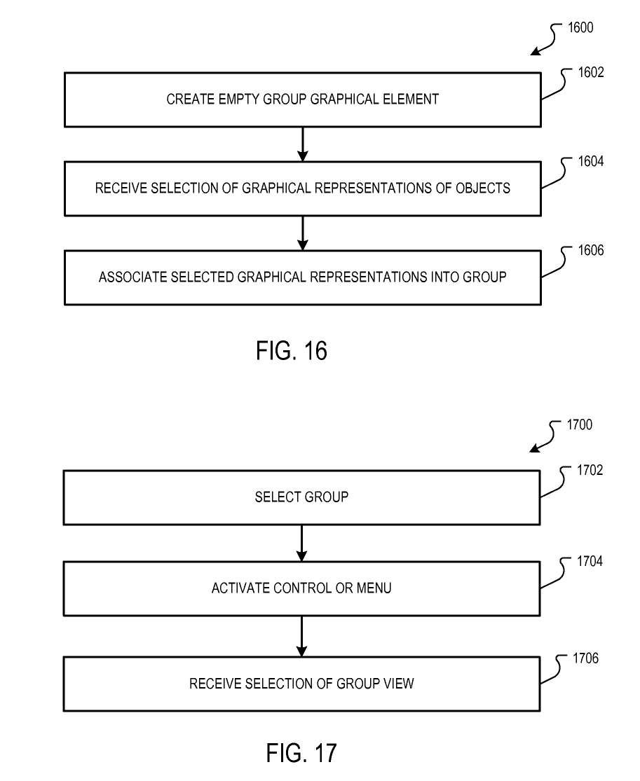

FIG. 16 is a flow diagram of an example process for creating an empty group and associating graphical representations into the empty group. At stage 1602, an empty group is created. For example, a user may create the empty group by selected an option from a menu provided within the desktop environment.

At stage 1604, graphical representations are selected. For example, selection can be accomplished in response to a user selection of one or more graphical representations using a mouse pointer, keyboard input or other input device.

At stage 1606, the selected graphical representations are associated with the group. For example, a menu option is selected by user input to associate the selected graphical representations within the empty group. An operating system can then, for example, associate the graphical representations with the group.

FIG. 17 is a flow diagram of an example process for applying a view to a group. At stage 1702, a group is selected. For example, a user may select the group using a mouse pointer, or dragging the mouse pointer over the graphical representations.

At stage 1704, a menu or control is activated. For example, a menu within the desktop environment is selected, or a context-sensitive pop-up menu is activated in response to a mouse-over of the graphical representations, a keyboard key combination, a keyboard/mouse operation, or by a control provided in the desktop environment.

At stage 1706, a view selection is received. For example, a view is selected from options provided in the menu. The selected view is applied to the group and the items contained therein by the operating system or UI engine.

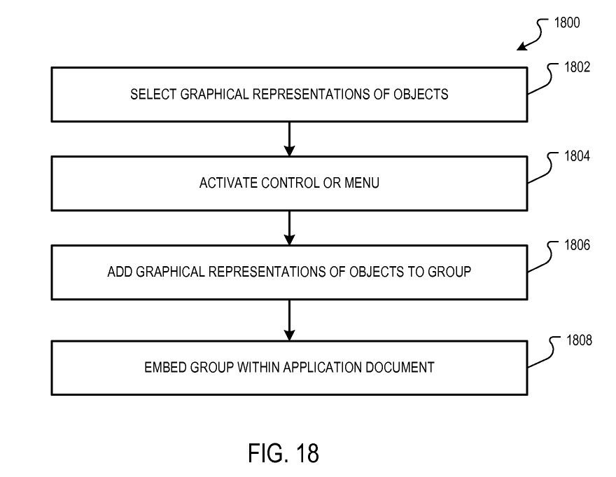

FIG. 18 is a flow diagram of an example process for creating a group in an application environment. At stage 1802, a selection of graphical representations of system objects is received. For example, a user may select a graphical representation using a mouse or keyboard input.

At stage 1804, a menu or control is activated. For example, a menu within the application environment is selected, or a context-sensitive pop-up menu is activated in response to a mouse-over of the graphical representations, a keyboard key combination, a keyboard/mouse operation, or by a control provided in the application environment.

At stage 1806, the graphical representations are associated with the group. For example, a user selects a menu item to create a group containing the selected graphical representations, and the operating system can associate the graphical representations with the group.

At stage 1808, an operation is applied to the group and the group is embedded into the application document. For example, the application environment executes instructions to embed the group into the application document. When the embedded group is selected, the operation is executed on the items with the group.

The apparatus, methods, flow diagrams, and structure block diagrams described in this patent document may be implemented in computer processing systems including program code comprising program instructions that are executable by the computer processing system. Other implementations may also be used. Additionally, the flow diagrams and structure block diagrams described in this patent document, which describe particular methods and/or corresponding acts in support of steps and corresponding functions in support of disclosed structural means, may also be utilized to implement corresponding software structures and algorithms, and equivalents thereof.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A computer-implemented method, comprising:
receiving a selection of graphical representations of distinct system objects;
creating a group containing the graphical representations;
associating the graphical representations within the group by an operation; and
applying the operation to the group.

2. The method of claim 1, wherein creating the group containing the graphical representations comprises displaying a context-sensitive control element in response to receiving the selection.

3. The method of claim 1, comprising displaying the group as a graphical element in a graphical user interface.

4. The method of claim 3, further comprising displaying the group within a view, wherein the view is one of a list view, an icon view, a thumbnail picture view, a content view, or an application view as the view.

5. The method of claim 4, comprising displaying graphical representations within the group as having distinct views.

6. The method of claim 3, comprising collapsing the group into a stack.

7. The method of claim 1, comprising:
receiving a selection of the group;
displaying an operation selection element; and
applying an operation selected from the operation selection element to the group.

8. The method of claim 1, comprising defining a sub-group within the group.

9. The method of claim 8, comprising:
receiving a selection of the sub-group; and
applying an operation to the sub-group.

10. The method of claim 9, wherein the operation applied to the sub-group is a different than a group operation applied to the group.

11. The method of claim 1, wherein creating the group of the graphical representations is performed within an application environment.

12. The method of claim 11, comprising embedding the group within an application document.

13. The method of claim 1, comprising creating the group as an empty group prior to placing the graphical representations of objects into the group,

14. A computer readable medium storing instructions that are executable by a processing device, and upon such execution cause the processing device to:
receive a selection of graphical representations of objects;
associate the selection of graphical representations of objects into a group in accordance with an operation to be performed on the group; and
perform an operation on the group in response to a user input.

15. The computer readable medium of claim 14, wherein upon execution the instructions cause the processing device to display the group as a graphical element in a graphical user interface.

16. The computer readable medium of claim 15, wherein upon execution the instructions cause the processing device to display the group having one of a list view, an icon view, a thumbnail picture view, a content view, or an application view.

17. The computer readable medium of claim 16, wherein upon execution the instructions cause the processing device to display graphical representations within the group having distinct views.

18. The computer readable medium of claim 15, wherein upon execution the instructions cause the processing device to collapse the group into a stack.

19. The computer readable medium of claim 14, wherein upon execution the instructions cause the processing device to:
receive a selection of a sub-group within the group; and
apply a second operation to the sub-group.

20. The computer readable medium of claim 14, wherein upon execution the instructions cause the processing device to create the group within an application environment.

21. A graphical user interface, comprising:
a group element including graphical representations of at least two distinct types of system objects; and
a control element associated with the group element, the control element including an operation that is performed on the group upon receipt of a user input.

22. The graphical user interface of claim 21, wherein the group element contains sub-group elements.

23. The graphical user interface of claim 21, wherein the group element is displayed as one of a list view, an icon view, a thumbnail picture view, a content view, or an application view.

24. The graphical user interface of claim 23, wherein the graphical representations within the group have distinct views.

25. The graphical user interface of claim 21, wherein the group element is displayed as a stack.

26. The graphical user interface of claim 21, wherein the group element is displayed within an application environment.
